(19) United States
(12) Patent Application Publication
(10) Pub. No.: US 2003/0162453 A1
(43) Pub. Date: Aug. 28, 2003

(54) Simulated leather and fabric substrate therefor

(76) Inventor: Charles E. Dalbec, Spartanburg, SC (US)

Correspondence Address: Milliken & Company, Legal Department, M-495, P.O. Box 1927, Spartanburg, SC, 29304, US

(21) Appl. No.: 10/083,847

(22) Filed: Feb. 27, 2002

(51) Int. Cl. B32B 27/12; D04H 11/00; D03D 27/00; B32B 1/00; B32B 33/00

(52) U.S. Cl. 442/149; 428/85; 442/208

(57) ABSTRACT

A fabric substrate with a leather simulation film adhered to the fabric substrate by an adhesive. The fabric substrate is a satin weave fabric with the fill side being napped, and the warp side being napped and sheared. The adhesive secures the film to the napped and sheared warp side of the fabric substrate.

### BACKGROUND

Typically, simulated leather products, such as “vinyl” leather products have a fabric substrate with a film bonded to the substrate. The fabric substrate provides a structure, and the film provides a surface that simulates leather. However, the fabric substrate contributes significantly to the characteristics of the overall coated substrate. The fabric substrates contribute to properties of the overall coated product, such as softness and the break line. Therefore, there is a need for fabric substrates that improve these qualities of the overall coated product.

### BRIEF DESCRIPTION OF THE DRAWINGS

The present invention can be better understood with reference to the following drawings:

FIG. 1 is a cross-sectional view of one embodiment of the present invention;

FIG. 2 is a cross-sectional view of the fabric substrate illustrated in FIG. 1.

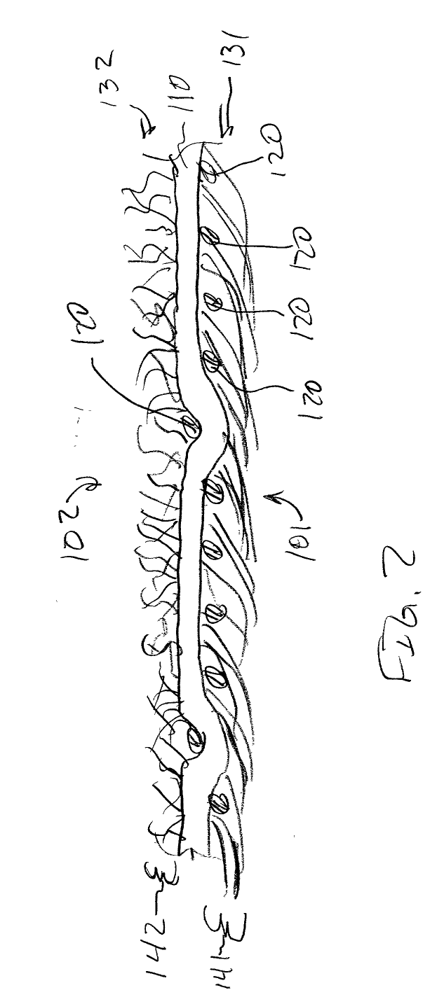

### DETAILED DESCRIPTION

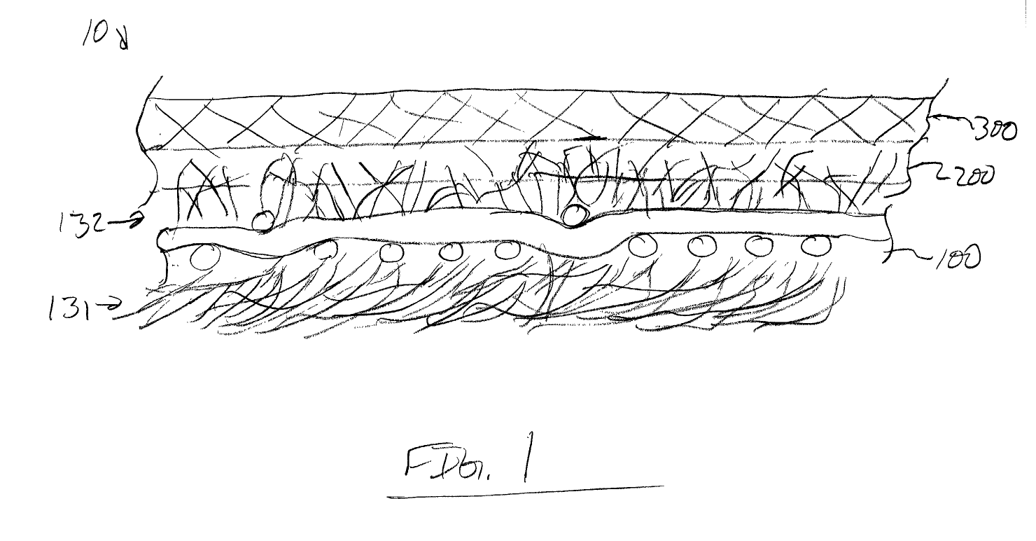

Referring now to the figures, and in particular to FIG. 1, there is shown an embodiment of the present invention illustrated as the coated fabric 10 which simulates leather. As illustrated, the coated fabric 10 includes a substrate fabric 100 with a fill or first side 101 and a warp or second side 102, and a film covering 300 bonded to the second side 102 of the substrate fabric 100 by an adhesive 200.

The fabric substrate 100 comprises a satin weave fabric having a first, or warp, set of yarns 110 interwoven with a second, or fill, set of yarns 120 oriented in a substantially perpendicular direction to the first set of yarns 110. In one embodiment, the first set of yarns 110 are a 65% polyester and 35% cotton ring spun yarn with a 18.5 cotton count and using 1.2 denier per fiber polyester, and the second set of yarns 120 are a 65% polyester and 35% cotton ring spun yarns with a 11.6 cotton count yarn using 1.2 denier per fiber polyester. In another embodiment, the second set of yarns 120 are 8 cotton count yarn of 65% polyester and 35% cotton open end spun yarn.

As illustrated, the first yarn set 110 and the second yarn set 120 are woven in a satin weave, with four floats over one riser and a two count, five harness weave. However, it is anticipated that other satin weave patterns can be used in the present invention.

The first side 101 of the fabric substrate 100 is napped at a direction perpendicular to the second yarn set 120 to create a plurality of nap fibers 131 extending from the first surface 101 of the fabric substrate 100 to form a napped fiber layer 141. The fabric substrate 100 is napped and sheared on the second side 102 so as to produce a plurality of napped and sheared fibers 132 extending from second surface 102 in a napped and sheared fiber layer 142. As illustrated, the napped fibers 131 have a longer length than the napped and sheared fibers 132. Also as illustrated, the longer napped fibers 131 lay over towards the end of the napped fibers 131, and the napped and sheared fibers extend upwardly substantially without laying over at the ends. In this manner, the napped fiber layer 141 has substantially the same thickness as the napped and sheared fiber layer 142. In one embodiment, the fabric substrate has an overall thickness of about 45 mils.

In one method of forming the coated product 10, the fabric substrate 100 is first woven with the satin weave. After the fabric substrate 100 is woven, it is napped on the first surface 101 of the fabric 110 with the napping needles or devices moving generally perpendicular to the direction to the second set of yarns 120. After napping the first surface 101 of the fabric 100, the second surface 102 is napped and sheared, with the napping needles or devices moving generally perpendicular to the second set of yarns 120. The fabric substrate 100 can be steam treated to increase the pile effect, and the steam treatment can occur after napping of the first surface 101, and either before or after napping and sheering the second surface 102. After the second surface 102 is napped and sheared, the film covering 300 is applied to the second surface by the adhesive 200. In one embodiment, the adhesive 200 is a water or solvent born polymeric adhesive. The film covering 300 can be a urethane films vinyl film, or the like, which simulates the leather surface

What is claimed Is:

1. A simulated leather comprising:
a fabric substrate having a first side and a second side, the second side being napped and sheared;
a film coating; and
an adhesive layer securing the film coating to the second side of the fabric substrate.

2. The simulated leather according to claim 1, further comprising the first side of the fabric substrate being napped.

3. The simulated leather according to claim 1, further comprising the fabric substrate being a satin weave fabric.

4. The simulated leather according to claim 3, wherein the first side of the fabric substrate being a fill side of the satin weave, and the second side of the fabric substrate being a warp side of the satin weave fabric.
